(19) United States
(12) Patent Application Publication
(10) Pub. No.: US 2007/0240763 A1
(43) Pub. Date: Oct. 18, 2007

(54) Method and Device for Cleaning Dental Polishers

(76) Inventors: Thierry Casabonne, Bordeaux (FR); Dominique Mariaulle, Saint-Aubin du Medoc (FR)

Correspondence Address: YOUNG & THOMPSON, 745 SOUTH 23RD STREET, 2ND FLOOR, ARLINGTON, VA, 22202, US

(21) Appl. No.: 11/596,199

(22) PCT Filed: May 13, 2005
(86) PCT No.: PCT/FR05/01206

§ 371 Date: Jan. 10, 2007

(30) Foreign Application Priority Data
May 14, 2004 (FR) 0405296

(51) Int. Cl. B08B 9/02

(52) U.S. Cl. 137/15.01

(57) ABSTRACT

Method for maintaining and cleaning the conduits (2a, 3a) of a dental polisher (1), of the type that includes the pressurized spraying of a polishing powder (7) onto a tooth surface. The method includes an operational phase comprising the pressurized injection of a solution (9), in which the powder (7) is soluble, into at least some of the conduits (2a, 3a) through which the powder (7) passes.

The present invention relates to a method and a device for cleaning and maintaining polisher devices used in the field of dentistry, for cleaning dental surfaces by projecting on the latter, a polishing powder.

Many air polishers are thus known which, most of the time, resort to pneumatic means capable of ensuring projection on the dental surfaces of a flux formed with fine sodium bicarbonate particles surrounded with an annular water flux.

It was seen that the whole of devices of this type had the recurrent drawback of seeing the whole of their conduits being gradually blocked over time under the effect of the formation of agglomerates consisting of the mixture of the powder with the moisture of the propellant air. These agglomerates first of all form in the sunken areas of the jet nozzle and the conduits feeding the polisher, and they then finish over time, by providing quasi-total blocking of the nozzle as well as of the powder feed conduits of the latter.

Unblocking the main conduit of the nozzle conveying the abrasive powder is an operation which is particularly delicate to carry out because of its very small diameter (of the order of 0.6 mm). To do this, the use of metal wire with high fineness as a swab was suggested, which wire is introduced through this conduit and caused to perform a reciprocal movement inside the latter.

It was seen that, in the case of certain types of agglomerates, the wire notably because of its small diameter, lacks rigidity and tends to slip away, in front of the agglomerates, so that it cannot effectively provide unblocking of the conduits.

Further, in the thereby treated end pieces, it was seen that the reciprocal movements of the metal wire had the effect of creating microgrooves in the relevant areas, thereby forming for the future, adhesion areas promoting the formation of new agglomerates.

The object of the present invention is to propose a means with which cleaning, both as a preventive and curative means, of the different conduits used for conveying the polishing powder in the polishers may be provided.

The object of the present invention is thus a method for maintaining and cleaning conduits of a dental polisher of the type capable of projecting under pressure a polishing powder on a dental surface, characterized in that it comprises an operational phase consisting of injecting under pressure a solution in which this powder is soluble, into at least some of the conduits through which said powder passes,.

The solution may be stored in a container maintained under pressure by a propellant gas. Moreover, the powder may consist of sodium bicarbonate, and the liquid may then consist of a solution, notably an aqueous solution, of citric acid, the concentration of which will be about 4% by weight.

The object of the present invention is also a device for maintaining and cleaning conduits of a dental polisher conveying a powder for polishing dental surfaces, characterized in that it includes:
means for pressurizing a liquid behaving as a solvent with regards to said powder,
means capable of channeling this liquid towards the conduits of the polisher.

The pressurizing means may consist of a container of the “spray can” type containing said liquid and propellant gas. This container may be provided with an end piece capable of being sealably fitted into a cavity in communication with said conduit of the polisher.

Preferentially, the tip of the end piece will be provided with an annular groove receiving an O-ring seal.

In a particularly interesting embodiment of the invention, the powder will consist of sodium bicarbonate and the solvent liquid will comprise citric acid, preferentially a solution of the latter in water. The citric acid concentration in the water may be of the order of 4% by weight.

The cleaning means according to the invention have the advantage of not resorting to mechanical systems so that they observe the integrity of the different conduits conveying the polishing powder.

An embodiment of the present invention will be described hereafter as a non-limiting example, with reference to the appended drawing wherein:

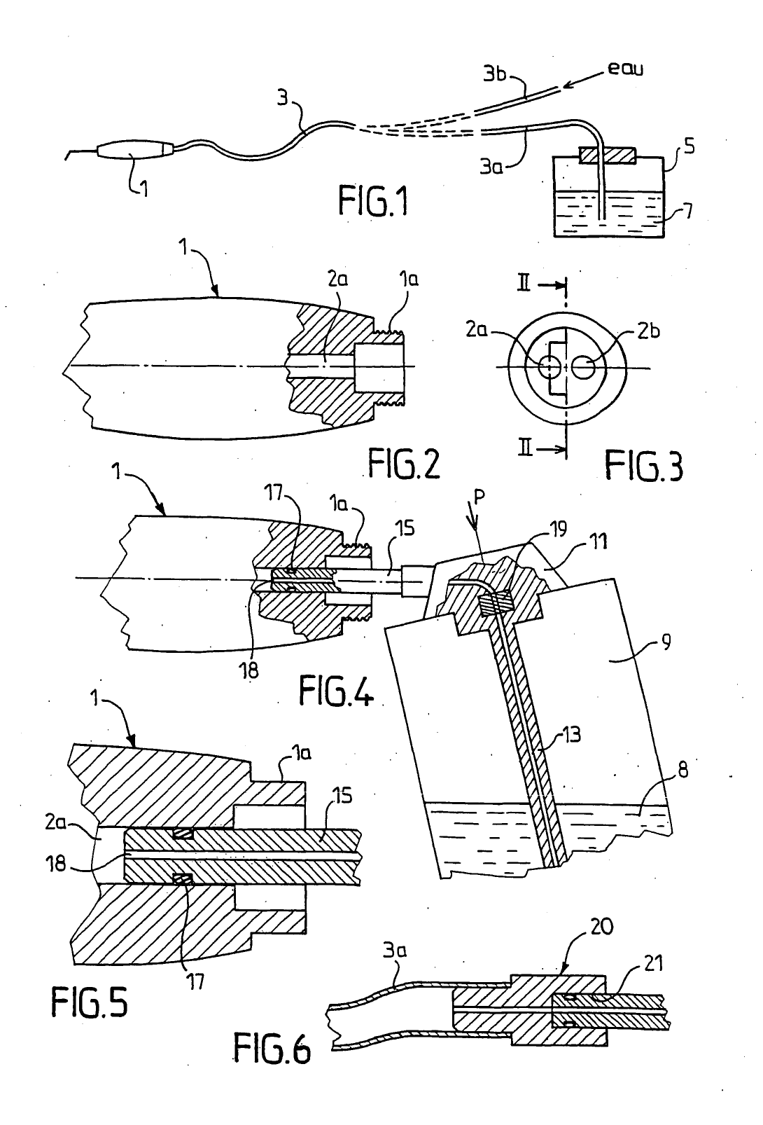

FIG. 1 is a schematic view of an air polisher and of its water and polishing powdery material feeding means.

FIG. 2 is a partial longitudinal sectional view of the rear portion of the air polisher illustrated in FIG. 1 along the line II-II of FIG. 3.

FIG. 3 is a view of the rear portion of the air polisher illustrated in FIG. 2.

FIG. 4 is a partial axial sectional view of the means for cleaning conduits applied to the air polisher illustrated in FIGS. 2 and 3.

FIG. 5 is a partial axial sectional view at an enlarged scale of the connection between the cleaning means and the rear portion of the air polisher.

FIG. 6 is a partial axial sectional view of an alternative embodiment of the present invention.

A dental hand part 1 of the air polisher type is schematically illustrated in FIG. 1. The rear portion 1a of this air polisher is provided with two feeding conduits 2a and 2b which are respectively connected via flexible conduits 3aand 3b, to a container 5 containing a powdery polishing material 7 in the present case consisting of sodium bicarbonate on the one hand, and via a pipe 3b to a pressurized water supply on the other hand.

As mentioned above, during the use of the device, powdery material agglomerates are formed which settle in the internal conduit 2a of the air polisher on the one hand, and in the feeding pipe 3a of the latter on the other hand.

According to the invention, a solution of citric acid in water was made with a citric acid concentration of at least 4% by weight, and this solution was introduced into a container 9 of the “spray can” type. This container, which is pressurized inside by means of gas, such as for example nitrogen, includes a head 11 provided at its base with a conduit 13 immersed in the solution 8 and at its external portion with a nozzle 15, the diameter of which is slightly less than that of the conduit 2a of the air polisher, and its end portion is provided with an O-ring seal 17. In a known way, and not illustrated in the drawing, the head 11 is provided with blocking means 19 such that when pressure P is exerted on the latter head, the blocking means are hidden away, allowing the solution 8 contained in the container 9 to be projected through the central channel 18 of the nozzle 15.

The user may then periodically proceed with preventive cleaning of the conduit 2a of his/her polisher or with unblocking this conduit when the agglomerates are such that they interfere with normal flow of the powdery polishing material.

During use, the agglomerates may also form in the flexible pipe 3a connecting the container 5 to the air polisher 1, and the user in order to proceed with the cleaning of the latter, may also resort to the container 9. To do this, an adapter end piece 20, the front portion of which will have a suitable diameter for it to be sealably fitted into the flexible pipe 3a and a rear portion provided with a recess 21 capable of receiving the nozzle 15 of the container 9, may be provided.

Of course, according to the invention one may resort to any other means with which the cleaning liquid may be propelled under pressure both into the flexible pipe 3a and into the conduit 2a of the polisher, and notably to spraying means of the manual type.

1-11. (canceled)

12. A method for maintaining and cleaning conduits (2a, 3a) of a dental polisher (1) of the type capable of projecting under pressure a polishing powder (7) onto a dental surface, characterized in that it comprises an operational phase consisting of injecting under pressure a solution (8) in which this powder (7) is soluble, into at least some of the conduits (2a, 3a) through which said powder (7) passes.

13. The method according to claim 12, characterized in that the solution (8) is stored in a container (9) held under pressure by a propellant gas.

14. The method according to claim 12, characterized in that the powder consists of sodium bicarbonate and the liquid consists of citric acid solution.

15. The method according to claim 14, characterized in that the citric acid concentration in the water is about 4% by weight.

16. A device for maintaining and cleaning conduits (2a, 3a) of a dental polisher (1), conveying a powder (7) for polishing dental surfaces, characterized in that it includes:
means (9) for pressurizing a liquid (8) behaving as a solvent with respect to said powder (7),
means capable of channeling this liquid towards the conduits (2a, 3a) of the polisher (1).

17. The device according to claim 16, characterized in that the pressurizing means consist of a spray container (9) containing said liquid (8) and of a propellant gas.

18. The device according to claim 16, characterized in that the container (9) is provided with an end piece (15) capable of being sealably fitted into a cavity (2a) in communication with said conduit of the polisher.

19. The device according to claim 18, characterized in that the tip of the end piece is provided with an annular groove receiving an O-ring seal (17).

20. The device according to claim 16, wherein said powder consists of sodium bicarbonate, characterized in that the solvent liquid comprises citric acid.

21. The device according to claim 20, characterized in that said liquid consists of a solution of citric acid in water.

22. The device according to claim 21, characterized in that the solution contains about 4% by weight of citric acid.
